(19) United States
(12) Patent Application Publication
(10) Pub. No.: US 2026/0074220 A1
(43) Pub. Date: Mar. 12, 2026

(54) POSITIVE ELECTRODE ACTIVE MATERIAL, SECONDARY BATTERY, AND ELECTRIC DEVICE

(71) Applicant: SUNWODA MOBILITY ENERGY TECHNOLOGY CO., LTD., Guangdong (CN)

(72) Inventors: Dong XIE, Guangdong (CN); Yunpeng OUYANG, Guangdong (CN); Yi HU, Guangdong (CN)

(73) Assignee: SUNWODA MOBILITY ENERGY TECHNOLOGY CO., LTD., Guangdong (CN)

(21) Appl. No.: 19/392,015

(22) Filed: Nov. 17, 2025

Related U.S. Application Data
(63) Continuation of application No. PCT/CN2023/141005, filed on Dec. 22, 2023.

(30) Foreign Application Priority Data
May 18, 2023 (CN) 202310567615.1

(51) Int. Cl. H01M 4/525; C01G 53/504; H01M 4/02

(52) U.S. Cl. CPC H01M 4/525; C01G 53/504; C01P 2002/50; C01P 2004/01; C01P 2006/40; H01M 2004/021; H01M 2004/028

(57) ABSTRACT

A positive electrode active material, a secondary battery, and an electric device are disclosed. The positive electrode active material satisfies the following relationship: 300≤P*D/Δθ≤800; where P represents the porosity of the positive electrode active material, with a unit of %; D represents the crystal plane dimension of the (110) crystal plane of the positive electrode active material, with a unit of Å; and Δθ represents a splitting degree between a diffraction angle of the (110) crystal plane and that of (108) crystal plane of the positive electrode active material, with a unit of °.

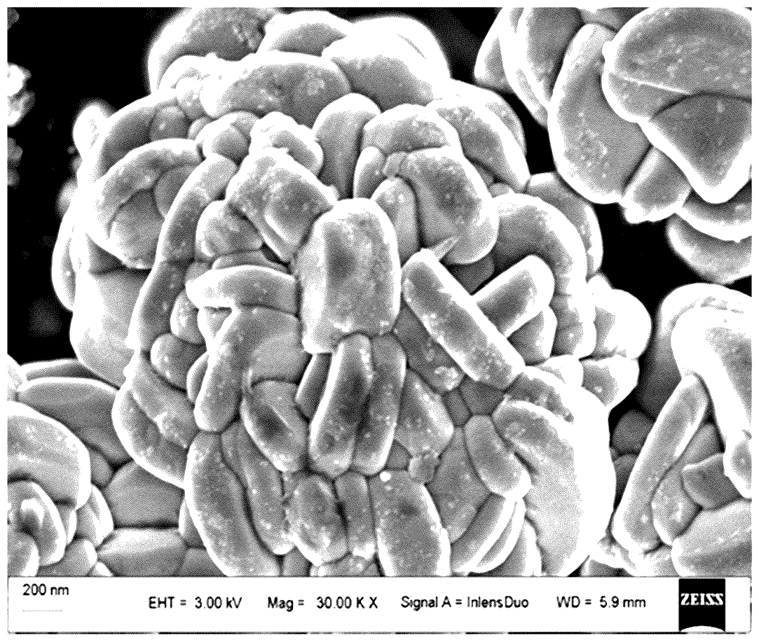

### CROSS-REFERENCE TO RELATED APPLICATION

This application is a continuation of International Application of PCT application serial No. PCT/CN2023/141005, filed on Dec. 22, 2023, which claims priority to Chinese Patent Application No. 202310567615.1, filed on May 18, 2023, which are hereby incorporated by reference in their entireties.

### TECHNICAL FIELD

The present disclosure generally relates to the field of new energy technology, and in particular to a positive electrode active material and its secondary battery, and an electric device.

### RELATED ART

With continuous development of technology, higher and more demands have been put forward for battery performance. Batteries are not only required to have high pulse power, but also high cycle stability. However, the pulse power and cycle performance of existing batteries cannot satisfy the needs of modern society. Since battery performance largely depends on electrode materials, it is crucial to develop an electrode material that combines high pulse power with long cycle performance.

### SUMMARY OF INVENTION

In a first aspect, the present disclosure relates to a positive electrode active material satisfying the following relationship:
300≤P*D/Δθ≤800; where P represents a porosity of the positive electrode active material, D represents a crystal plane dimension of (110) crystal plane of the positive electrode active material, and Δθ represents a splitting degree between a diffraction angle of the (110) crystal plane and that of (108) crystal plane of the positive electrode active material.

In some embodiments, the porosity P of the positive electrode active material satisfies 30%≤P≤65%.

In some embodiments, the crystal plane dimension D of the (110) crystal plane of the positive electrode active material satisfies 500 Å≤D≤1000 Å.

In some embodiments, in the positive electrode active material, the splitting degree Δθ between the diffraction angle of the (110) crystal plane and that of (108) crystal plane of the positive electrode active material satisfies 0.3°≤Δθ≤0.8°.

In some embodiments, the positive electrode active material includes a compound having a chemical formula of LiₓNi_{y}Co_{z}MnₖMₚO₂, where M includes at least one of B, Y, Nb, In, La, Zr, Ce, W, Al, Ti, Sr, Mg, Sb, V, Zn, Cu, Cr, and Fe, 0.8≤x≤1.2, 0<y<1, 0<z<1, 0<k<1, and 0≤p≤0.1.

In some embodiments, the positive electrode active material includes a secondary particle, and the secondary particle includes a primary particle.

In some embodiments, a particle size ratio of the primary particle to the secondary particle is 1:(10-1000).

In the other aspect, the present disclosure relates to a secondary battery including a negative electrode active material and the positive electrode active material described herein.

In some embodiments, a leakage current I of the secondary battery is 0 A to 0.1 A at 60° C. under a voltage of 4.5 V to 4.7 V.

In further aspect, the present disclosure relates to an electric device including the secondary battery described herein.

In some embodiments, the porosity P of the positive electrode active material, the crystal plane dimension D of the (110) crystal plane of the positive electrode active material, and the splitting degree Δθ between the diffraction angle of the (110) crystal plane and that of (108) crystal plane of the positive electrode active material in the present disclosure satisfy 300≤P*D/Δθ≤1000, ensuring that the lithium-ion battery prepared with this positive electrode active material has high pulse power while having significantly improved cycle performance.

### BRIEF DESCRIPTION OF DRAWINGS

To describe the technical solutions of the present disclosure more clearly, the following briefly introduces the accompanying drawings required for describing the embodiments. Apparently, the accompanying drawings in the following description illustrate some embodiments of the present disclosure, and persons of ordinary skill in the art may still obtain other drawings from these accompanying drawings without creative effort.

FIGURE shows an electron microscope image of the positive electrode active material prepared according to Example 1 of the present disclosure.

### DESCRIPTION OF EMBODIMENTS

The technical solutions in the embodiments will hereinafter be described in a clear and complete manner. It is obvious that the embodiments described below are only a part of the embodiments of the present disclosure, not all of them. Based on the embodiments disclosed in the disclosure, all other embodiments obtained by those skilled in the art without creative labor fall within the scope of protection of the present disclosure.

It should be understood that when used in this description and the appended claims, the terms “include” and “comprise” indicate the presence of the described features, entireties, steps, operations, elements, and/or components, but do not exclude the presence or addition of one or more other features, entireties, steps, operations, elements, components, and/or their combinations.

It should also be understood that the terminology used herein is intended solely for the purpose of describing specific embodiments and is not intended to limit the present disclosure. As used in the description and the appended claims of the present disclosure, unless the context clearly indicates otherwise, singular forms such as “an”, “a,” and “the” are intended to include plural forms.

An embodiment of the present disclosure provides a positive electrode active material satisfying the following relationship:
300≤P*D/Δθ≤800; where P represents a porosity of the positive electrode active material, with a unit of %; D represents a crystal plane dimension of (110) crystal plane of the positive electrode active material, with a unit of Å; Δθ represents a splitting degree between a diffraction angle of the (110) crystal plane and that of (108) crystal plane of the positive electrode active material, with a unit of °.

In some embodiments, P*D/Δθ may be any one of 300, 320, 350, 380, 390, 400, 420, 450, 480, 500, 520, 540, 550, 570, 600, 650, 670, 690, 700, 720, 750, 780, or 800, or a range formed by any two thereof.

In some embodiments, the positive electrode active material satisfies 300≤P*D/Δθ≤700. In some embodiments, the positive electrode active material satisfies 325≤P*D/Δθ≤600. By controlling various process parameters during the preparation of the positive electrode active material, the porosity, crystal plane dimension, and crystallinity of the active material can be appropriately regulated to make the value of P*D/Δθ fall within the range of the disclosure, which is conductive to improving the structure stability of the positive electrode active material and wetting of electrolyte, thereby making the resulting battery have superior low-temperature power performance and better long-term life.

In some embodiments, the porosity P of the positive electrode active material satisfies 30%≤P≤65%. In some embodiments, P may be any one of 30%, 33%, 35%, 38%, 40%, 43%, 45%, 48%, 50%, 53%, 55%, 58%, 60%, or 65%, or a range formed by any two thereof. The porosity of the positive electrode active material within the range of the present disclosure can ensure sufficient wetting of electrolyte to facilitate capacity utilization and at the same time ensure structural stability during charge-discharge cycles, reduce side reaction, and extend battery life.

In some embodiments, 32%≤P≤59%.

In some embodiments, 34%≤P≤57%.

In some embodiments, the crystal plane dimension D of the (110) crystal plane of the positive electrode active material satisfies 500 Å≤D≤1000 Å. In some embodiments, D can be any one of 500 Å, 520 Å, 540 Å, 550 Å, 570 Å, 600 Å, 650 Å, 670 Å, 690 Å, 700 Å, 720 Å, 750 Å, 780 Å, 800 Å, 830 Å, 850 Å, 890 Å, 900 Å, 950 Å, or 1000 Å, or a range formed by any two thereof. The crystal plane dimension D of the (110) crystal plane of the positive electrode active material within the range of the present disclosure facilitates rapid transport of lithium ions, thereby enhancing rate performance and power performance of the battery.

In some embodiments, 510 Å≤D≤840 Å.

In some embodiments, 500 Å≤D≤700 Å. When the crystal plane dimension D of the (110) crystal plane of the positive electrode active material falls within the above range, it enables the battery to have more superior overall performance.

In some embodiments, in the positive electrode active material, the splitting degree Δθ between the diffraction angle of the (110) crystal plane and that of (108) crystal plane of the positive electrode active material satisfies 0.3°≤Δθ≤0.8°. In some embodiments, Δθ may be any one of 0.3°, 0.35°, 0.37°, 0.4°, 0.43°, 0.45°, 0.47°, 0.5°, 0.52°, 0.55°, 0.57°, 0.6°, 0.63°, 0.65°, 0.68°, 0.7°, 0.73°, 0.75°, 0.77°, or 0.8°, or a range formed by any two thereof. The splitting degree Δθ between the diffraction angle of the (110) crystal plane and that of (108) crystal plane being within the range of the present disclosure makes the positive electrode active material have better integrity of layered structure and more superior crystallization property, thereby enabling the battery to have better overall performance.

In some embodiments, 0.36°≤Δθ≤0.73°.

In some embodiments, 0.38°≤Δθ≤0.71°.

In some embodiments, 0.41°≤Δθ≤0.69°. When Δθ is within the above ranges, the overall performance of the secondary battery can be further improved.

In some embodiments, the positive electrode active material includes a compound with the chemical formula of LiₓNi_{y}Co_{z}MnₖMₚO₂, where M includes at least one of B, Y, Nb, In, La, Zr, Ce, W, Al, Ti, Sr, Mg, Sb, V, Zn, Cu, Cr, and Fe, 0.8≤x≤1.2, 0<y<1, 0<z<1, 0<k<1, and 0≤p≤0.1.

In some embodiments, 0.3<y<0.95.

In some embodiments, 0.45<y<0.90.

In some embodiments, 0.45<y<0.85.

In some embodiments, 0.45<y<0.75.

In some embodiments, M includes B, and at least one of Y, Nb, In, La, Zr, Ce, W, Al, Ti, Sr, Mg, Sb, V, Zn, Cu, Cr, and Fe.

In some embodiments, M includes B and W, and at least one of Y, Nb, In, La, Zr, Ce, Al, Ti, Sr, Mg, Sb, V, Zn, Cu, Cr, and Fe.

In some embodiments, the positive electrode active material includes a secondary particle, and the secondary particle includes a primary particle. In some embodiments, the particle size ratio of the primary particle to the secondary particle is 1:(10-1000).

In some embodiments, the particle size ratio of the primary particle to the secondary particle is 1:(100-1000).

In some embodiments, the particle size ratio of the primary particle to the secondary particle may be 1:100, 1:200, 1:400, 1:600, 1:800, 1:1000, or a range formed by any two thereof. When the primary particle and the secondary particle are within the above range, it is beneficial for shortening the transport pathway of lithium ions, thereby improving the power performance and cycle life of the battery.

In some embodiments, the surface of the positive electrode active material includes Li₂CO₃ and/or LiOH. Based on the mass of the positive electrode active material, the content of Li₂CO₃ ranges from 500 ppm to 1000 ppm, and the content of LiOH ranges from 1000 ppm to 3000 ppm. Residual lithium is subjected to decomposition and gas production during charge-discharge of battery, which impacts long-term performance and safety. The surface of the positive electrode active material proposed in the embodiments of the present disclosure has low residual lithium, thereby enabling lithium-ion batteries to exhibit excellent performance.

In some embodiments, a method for preparing the positive electrode active material of the present disclosure is provided, including: weighing nickel sulfate, cobalt sulfate, and manganese sulfate based on a specific element molar ratio of Ni:Co:Mn, and dissolving them in deionized water respectively; delivering each metal solution through pipelines to a reactor to form a mixed metal solution, with nitrogen gas being introduced as a protective atmosphere; adding into the mixed metal solution aqueous NaOH solution as a precipitating agent and ammonia water as a complexing agent; adjusting the ammonia water concentration and pH value of the solution in stages; and performing a reaction for 10 to 48 hours to obtain a precursor.

The precursor of positive electrode active material, lithium hydroxide, and doping raw material are mixed to obtain a first mixed material. The first mixed material is subjected to a first sintering process under an oxygen atmosphere to obtain an intermediate product, where the oxygen concentration of the oxygen atmosphere ranges from 30% to 60%.

In some embodiments, the molar ratio a/b of the precursor of positive electrode active material to lithium hydroxide is 1.03 to 1.09, where a is the molar content of lithium in the lithium hydroxide and b is the total molar content of Ni, Co, and Mn in the precursor of positive electrode active material. In some embodiments, a/b is 1.03.

In some embodiments, the metal oxide includes at least one of CoO₂, MnO₂, Al₂O, B₂O₃, ZrO₂, SnO₂, NbO, TiO₂, V₂O₃, WO₂ and MoO₃.

In some embodiments, mixing of the precursor of positive electrode active material, lithium hydroxide, and metal oxides may be performed in a high-speed mixer, and the mixing time may be set to 0.5 h to 2 h. In some embodiments, the mixing time is 1 h to 2 h.

In some embodiments, the first sintering may be performed in an atmosphere sintering furnace, the sintering atmosphere is an oxygen atmosphere, and the oxygen concentration of the oxygen atmosphere is 30% to 60%. In some embodiments, the oxygen concentration is 40% to 50%. In some embodiments, the parameters of the first sintering include a sintering temperature of 650° C. to 950° C. and a sintering time of 4 h to 24 h. In some embodiments, the sintering temperature may be 700° C. to 900° C., and the sintering time may be 8 h to 12 h.

In some embodiments, the intermediate product is mixed with the metal oxide to obtain a second mixed material. The second mixed material is subjected to a second sintering to obtain the positive electrode active material.

In some embodiments, mixing of the intermediate product with the metal oxide may be performed in a high-speed mixer, and the mixing time may be set to 0.5 h to 2 h. In some embodiments, the mixing time is 1 h to 2 h.

In some embodiments, the second sintering may be performed in an atmosphere sintering furnace, and the sintering atmosphere is an air atmosphere. The parameters of the second sintering include: a sintering temperature of 200° C. to 500° C. and a sintering time of 6 h to 14 h. In some embodiments, the sintering temperature may be 300° C. to 500° C., and the sintering time may be 7 h to 12 h.

In some embodiments, the control of the crystal plane dimension of the (110) crystal plane of the positive electrode active material, the splitting degree between the diffraction angle of the (110) crystal plane and that of (108) crystal plane of the positive electrode active material, and the porosity the positive electrode active material is influenced by the aforementioned preparation process. By adjusting the ammonia water concentration and pH value to regulate the structure of the precursor and the growth rate of crystal plane of the precursor, the precursors with different active crystal planes and loose degrees are obtained. And then, the positive electrode active material described in the present disclosure is obtained by adjusting the lithium ratio, temperature, and time of the sintering and so on. In the process described in the present disclosure, the preparation of the positive electrode active material is conductive to obtaining crystals with long-range order and uniformity, which facilitates the positive electrode active material to maintain structural integrity during long-term charging and discharging and enhances the cycling performance of the battery.

In the other aspect, the present disclosure provides a secondary battery including a negative electrode active material and the positive electrode active material described in the present disclosure.

In some embodiments, the leakage current I of the secondary battery is 0 A to 0.1 A at 60° C. under a voltage of 4.5 V to 4.7 V. The secondary battery of the present disclosure has the leakage current being within a narrow range, and has superior cycling performance.

In some embodiments, after charging the secondary battery at a constant current to a predetermined set voltage, the secondary battery is charged at constant-voltage with the set voltage for a preset time. In some embodiments, the set voltage is 4.5V to 4.7V, and the preset time is 15 h to 25 h.

In some embodiments, whether the cycling performance is good or not can be determined from the magnitude of the leakage current of the secondary battery. In some embodiments, multiple levels of leakage current ranges may be set, and the quality of cycling performance of the secondary battery can be determined based on the leakage current within each range.

In another further aspect, the present disclosure provides an electric device including the secondary battery described in the present disclosure.

### EXAMPLE

### Example 1

Step 1: a precursor of positive electrode active material M(OH)₂, LiOH, and ZrO₂ are add in a molar ratio of 1:1.09:0.002 into a high-speed mixer and mixed for 1 hour to obtain a first mixed material. The first mixed material is placed into an atmosphere sintering furnace for first sintering to obtain an intermediate product. The parameters of the first sintering include: sintering temperature of 880° C., sintering time of 8 h, and sintering atmosphere being an oxygen atmosphere with O₂ concentration of 50%.

The chemical formula of the positive electrode active material precursor is [Ni_{0.5}Co_{0.2}Mn_{0.3}](OH)₂. The positive electrode active material precursor is prepared via the coprecipitation method. The positive electrode active material precursor has a loose porous structure. The molar ratio a/b of lithium hydroxide to the positive electrode active material precursor is 1.09, where a is the molar content of lithium in lithium hydroxide, and b is the total molar content of Ni, Co, and Mn in the positive electrode active material precursor. The molar content of nickel in lithium nickel manganese cobalt oxide is 50% of the total molar content of nickel, cobalt, and manganese.

Step 2: the intermediate product of Step 1 and B₂O₃ are added in a molar ratio of 1:0.001 into a high-speed mixer and mixed for 1 hour to obtain a second mixed material. The second mixed material is placed into an atmosphere sintering furnace for a second sintering to obtain the positive electrode active material. The parameters of the second sintering include: sintering temperature of 300° C., sintering time of 8 h, and sintering atmosphere being air atmosphere.

### Preparation of Lithium-Ion Battery

(1) Preparation of positive electrode plate: the positive electrode active material, acetylene black, and polyvinylidene fluoride are dispersed in N-methylpyrrolidone (NMP) at a mass ratio of 92:6:2. The resulting slurry is coated onto 12 m aluminum foil, dried in a 120° C. oven, and then cold-pressed and slit to obtain the positive electrode plate.
(2) Preparation of electrolyte: ethylene carbonate (EC), ethyl methyl carbonate (EMC), and diethyl carbonate (DEC) are mixed in a volume ratio of 20:20:60 to obtain a mixed solution. In a glove box under argon atmosphere with moisture content<10 ppm, fully dried LiPF₆ with a concentration of 1 mol/L is dissolved in the mixed solution and mixed uniformly to obtain the electrolyte.
(3) Preparation of negative electrode plate: graphite, sodium carboxymethyl cellulose, styrene-butadiene rubber, and acetylene black are mixed at a mass ratio of 95:1:2:2; deionized water is added; and a slurry of negative electrode is obtained under the action of a vacuum mixer. The slurry of negative electrode is uniformly coated onto a copper foil with a thickness of 8 μm, dried in an oven at 120° C., then cold-pressed and slit to obtain the negative electrode plate.
(4) Preparation of a lithium-ion battery: the positive electrode plate, the separator, and the negative electrode plate are stacked in sequence, the separator being positioned between the positive and negative electrode plates for insulation, and wound into a square bare core; the bare core is put into an aluminum-plastic film, baked at 80° C. to remove moisture, subjected to electrolyte injection and sealed, followed by standing, cold and hot pressing, formation, clamping and capacity grading and other process, obtaining the lithium-ion battery.

The preparation methods of the remaining examples and comparative examples refer to Example 1, with the differences being shown in Table 1.

TABLE 1

| | | | | Molar ratio of | Molar ratio of |
|---|---|---|---|---|---|
| | Temperature | Temperature | | M(OH)₂, | the intermediate |
| | (° C.) and time | (° C.) and time | Type of metal | LiOH and the | product of |
| | (h) of the | (h) of the | oxides of the | metal oxide of | Step 1 to the |
| | first | second | first and second | the first | metal oxide of the |
| Number | sintering | sintering | sintering | sintering | second sintering |
| Example 1 | 880; 8 | 300; 8 | ZrO₂; B₂O₃ | 1:1.09:0.002 | 1:0.001 |
| Example 2 | 700; 8 | 300; 8 | ZrO₂; B₂O₃ | 1:1.09:0.002 | 1:0.001 |
| Example 3 | 750; 8 | 300; 8 | ZrO₂; B₂O₃ | 1:1.09:0.002 | 1:0.001 |
| Example 4 | 1000; 8 | 300; 8 | ZrO₂; B₂O₃ | 1:1.09:0.002 | 1:0.001 |
| Example 5 | 880; 4 | 300; 8 | ZrO₂; B₂O₃ | 1:1.09:0.002 | 1:0.001 |
| Example 6 | 880; 12 | 300; 8 | ZrO₂; B₂O₃ | 1:1.09:0.002 | 1:0.001 |
| Example 7 | 880; 24 | 300; 8 | ZrO₂; B₂O₃ | 1:1.09:0.002 | 1:0.001 |
| Example 8 | 880; 8 | 500; 8 | ZrO₂; B₂O₃ | 1:1.09:0.002 | 1:0.001 |
| Example 9 | 880; 8 | 500; 8 | ZrO₂; TiO₂ | 1:1.09:0.002 | 1:0.001 |
| Example 10 | 880; 8 | 500; 8 | ZrO₂; WO₃ | 1:1.09:0.002 | 1:0.001 |
| Example 11 | 880; 8 | 300; 8 | MgO; B₂O₃ | 1:1.09:0.002 | 1:0.001 |
| Example 12 | 880; 8 | 300; 8 | Al₂O₃; B₂O₃ | 1:1.09:0.002 | 1:0.001 |
| Example 13 | 880; 8 | 300; 8 | WO₃; B₂O₃ | 1:1.09:0.002 | 1:0.001 |
| Example 14 | 880; 8 | 300; 8 | Al₂O₃+WO₃; | 1:1.09:0.002 | 1:0.001 |
| | | | B₂O₃ | | |
| Example 15 | 880; 8 | 300; 8 | ZrO₂+WO₃; | 1:1.09:0.002 | 1:0.001 |
| | | | B₂O₃ | | |
| Example 16 | 880; 8 | 300; 8 | TiO₂+WO₃; | 1:1.09:0.002 | 1:0.001 |
| | | | B₂O₃ | | |
| Example 17 | 880; 8 | 300; 8 | ZrO₂; B₂O₃ | 1:1.09:0.008 | 1:0.001 |
| Example 18 | 880; 8 | 300; 8 | ZrO₂; B₂O₃ | 1:1.09:0.009 | 1:0.001 |
| Example 19 | 880; 8 | 300; 8 | ZrO₂; B₂O₃ | 1:1.09:0.005 | 1:0.001 |
| Example 20 | 880; 8 | 300; 8 | ZrO₂; B₂O₃ | 1:1.09:0.002 | 1:0.005 |
| Example 21 | 880; 8 | 300; 8 | ZrO₂; B₂O₃ | 1:1.09:0.002 | 1:0.006 |
| Example 22 | 550; 8 | 300; 8 | ZrO₂; B₂O₃ | 1:1.09:0.002 | 1:0.001 |
| Comparative | 400; 8 | 300; 8 | ZrO₂; B₂O₃ | 1:1.09:0.002 | 1:0.001 |
| Example 1 | | | | | |
| Comparative | 500; 8 | 300; 8 | ZrO₂; B₂O₃ | 1:1.09:0.002 | 1:0.001 |
| Example 2 | | | | | |

### Introduction of Test Method

### 1. Splitting Degree of the (110) and (108) Crystal Planes

A certain mass of positive electrode active material powder is placed in an X-ray powder diffractometer. The 2θ angles corresponding to the diffraction peaks of the (110) and (108) crystal planes are obtained via X-ray diffraction analysis, thereby obtaining the splitting degree of the (110) and (108) crystal planes.

### 2. Dimension of the (110) Crystal Plane

A certain mass of positive electrode active material powder is placed in an X-ray powder diffractometer. The dimension of the (110) crystal plane is obtained via X-ray diffraction analysis.

### 3. Porosity

The porosity of positive electrode active material can be tested by mercury porosimetry, as detailed in GB/T 21650.1-2008, “Determination of pore size distribution and porosity of solid materials by mercury porosimetry and gas adsorption”.

### 4. Power

The battery is charged at 1C constant current and constant voltage to 100% SOC. After standing for 10 minutes, the battery is discharged at 1C constant current for 30 minutes to adjust to 50% SOC. After standing in −20° C. environment for 180 minutes, the battery is discharged at 5C for 30 seconds. The voltage value before and after discharging is recorded, and the discharge power is calculated.

### 5. Test Method of Leakage Current

Lithium-ion batteries are prepared from the positive electrode active materials based on Examples and Comparative Examples.

The test method of leakage current includes: charging the lithium-ion battery to 4.7V at a constant current, then performing constant-voltage charging on the lithium-ion battery at 4.7V for 20 h, and obtaining the leakage current of lithium ions during 20-hour constant-voltage charging.

### 6. Test of Cyclic Performance

First, the battery voltage is calibrated to determine the voltages corresponding to 25% SOC and 85% SOC. The battery is placed in a 25° C. constant-temperature chamber for charge-discharge cycles, with the charge and discharge being conducted at 5C constant current. The battery's cycle capacity and number of cycles are recorded. The capacity retention rate after 5000 cycles is obtained.

Test results of Examples and Comparative Examples are shown in Table 2 below.

TABLE 2
Table of test results

| | Splitting degree | Dimension of | | | | | Capacity |
|---|---|---|---|---|---|---|---|
| | of the (110) | the (110) | | | | Leakage | retention rate |
| | and (108) crystal | crystal plane | Porosity | P*D/Δ | Power | current | after 5000 |
| Number | planes (°) | (Å) | P (%) | θ | (W) | (A) | cycles (%) |
| Example 1 | 0.62 | 527 | 0.63 | 535.50 | 90 | 0.05 | 89.9 |
| Example 2 | 0.52 | 575 | 0.72 | 796.15 | 85 | 0.13 | 73.8 |
| Example 3 | 0.58 | 567 | 0.68 | 664.76 | 84 | 0.11 | 76.2 |
| Example 4 | 0.68 | 480 | 0.5 | 352.94 | 67 | 0.08 | 84.6 |
| Example 5 | 0.51 | 554 | 0.65 | 706.08 | 83 | 0.08 | 82.6 |
| Example 6 | 0.64 | 504 | 0.57 | 448.88 | 77 | 0.07 | 83.3 |
| Example 7 | 0.67 | 436 | 0.52 | 338.39 | 65 | 0.06 | 86.2 |
| Example 8 | 0.62 | 539 | 0.61 | 530.31 | 91 | 0.04 | 90.1 |
| Example 9 | 0.61 | 524 | 0.62 | 532.59 | 89 | 0.05 | 88.4 |
| Example 10 | 0.63 | 530 | 0.64 | 538.41 | 92 | 0.06 | 89.3 |
| Example 11 | 0.62 | 518 | 0.62 | 518.00 | 89 | 0.06 | 83.3 |
| Example 12 | 0.63 | 532 | 0.63 | 532.00 | 97 | 0.03 | 91.2 |
| Example 13 | 0.65 | 578 | 0.64 | 569.11 | 98 | 0.02 | 92.4 |
| Example 14 | 0.64 | 589 | 0.62 | 570.59 | 96 | 0.03 | 91.5 |
| Example 15 | 0.65 | 605 | 0.63 | 586.38 | 99 | 0.02 | 92.9 |
| Example 16 | 0.64 | 606 | 0.62 | 587.06 | 98 | 0.03 | 93.1 |
| Example 17 | 0.3 | 570 | 0.42 | 798 | 82 | 0.14 | 72.3 |
| Example 18 | 0.4 | 550 | 0.5 | 693.75 | 83 | 0.12 | 71.4 |
| Example 19 | 0.8 | 603 | 0.47 | 354.26 | 65 | 0.9 | 82.5 |
| Example 20 | 0.45 | 700 | 0.35 | 544.44 | 87 | 0.7 | 87.4 |
| Example 21 | 0.42 | 800 | 0.32 | 609.52 | 85 | 0.6 | 86.5 |
| Example 22 | 0.43 | 420 | 0.31 | 302.8 | 61 | 0.15 | 70.2 |
| Comparative | 0.22 | 207 | 0.27 | 254.05 | 56 | 0.21 | 77.2 |
| Example 1 | | | | | | | |
| Comparative | 0.28 | 236 | 0.31 | 261.29 | 52 | 0.19 | 78.5 |
| Example2 | | | | | | | |

### Analysis of Experiment Results

From the comparison between Examples 1 to 16 and Comparative Examples 1 to 2, it can be seen that when 300≤P*D/Δθ≤800 falls within the range of the present disclosure, both the power and cyclic performance of the battery are improved, and the leakage current of the battery is reduced.

A comparison between Examples 1 to 7 and Comparative Examples 1 to 2 is conducted to analyze the effects of different sintering temperature and time process parameters on the material. Excessively high temperature and too long time result in high material crystallinity and large degree of separation, decrease of the (110) crystal plane and porosity, and decline of power performance; while excessively low temperature causes unsuccessful synthesis of material and poor performance.

In the above Examples, the description of each Example emphasizes specific aspects. Details omitted in certain Example can be referred to the relevant descriptions in other Examples.

Throughout the description of this specification, reference to the terms such as “an embodiment”, “some embodiments”, “example”, “specific example”, or “some examples” indicates that the specific features, structures, materials, or characteristics described in connection with that embodiment or example are included in at least one embodiment or example of the present disclosure. In this specification, the illustrative use of above terms should not be construed as necessarily referring to the same embodiment or example. Moreover, the specific features, structures, materials, or characteristics described may be appropriately combined in any one or more embodiments or examples. Additionally, those skilled in the art may combine and integrate different embodiments or examples described in this specification.

It will be apparent that those skilled in the art can make various modifications and variations to the present disclosure without departing from the spirit and scope thereof. Thus, such modifications and variations of the present disclosure fall within the scope of the claims of the present disclosure and their equivalents, and the present disclosure is also intended to encompass these modifications and variations.

The foregoing describes specific embodiments of the present disclosure, but the scope of protection of the present disclosure is not limited thereto. Any person skilled in the art may readily conceive of various equivalent modifications or substitutions within the technical scope disclosed by the present disclosure, and such modifications or substitutions should be encompassed within the scope of protection of the present disclosure. Therefore, the scope of protection of the present disclosure shall be determined by the scope of the claims.

What is claimed is:

1. A positive electrode active material, satisfying the following relationship:
300≤P*D/Δθ≤800;
wherein P represents a porosity of the positive electrode active material, with a unit of %; D represents a crystal plane dimension of (110) crystal plane of the positive electrode active material, with a unit of Å; Δθ represents a splitting degree between a diffraction angle of the (110) crystal plane and that of (108) crystal plane of the positive electrode active material, with a unit of °.

2. The positive electrode active material according to claim 1, wherein the porosity P of the positive electrode active material satisfies 30%≤P≤65%.

3. The positive electrode active material according to claim 1, wherein the crystal plane dimension D of the (110) crystal plane of the positive electrode active material satisfies 500 Å≤D≤1000 Å.

4. The positive electrode active material according to claim 2, wherein the crystal plane dimension D of the (110) crystal plane of the positive electrode active material satisfies 500 Å≤D≤1000 Å.

5. The positive electrode active material according to claim 1, wherein the splitting degree Δθ between the diffraction angle of the (110) crystal plane and that of (108) crystal plane of the positive electrode active material satisfies 0.3°≤Δθ≤0.8°.

6. The positive electrode active material according to claim 2, wherein the splitting degree Δθ between the diffraction angle of the (110) crystal plane and that of (108) crystal plane of the positive electrode active material satisfies 0.3°≤Δθ≤0.8°.

7. The positive electrode active material according to claim 3, wherein the splitting degree Δθ between the diffraction angle of the (110) crystal plane and that of (108) crystal plane of the positive electrode active material satisfies 0.3°≤Δθ≤0.8°.

8. The positive electrode active material according to claim 1, wherein the positive electrode active material comprises a compound having a chemical formula of LiₓNi_{y}Co_{z}MnₖMₚO₂, and wherein M comprises at least one of B, Y, Nb, In, La, Zr, Ce, W, Al, Ti, Sr, Mg, Sb, V, Zn, Cu, Cr, and Fe, 0.8≤x≤1.2, 0<y<1, 0<z<1, 0<k<1, 0≤p≤0.1.

9. The positive electrode active material according to claim 2, wherein the positive electrode active material comprises a compound having a chemical formula of LiₓNi_{y}Co_{z}MnₖMₚO₂, and wherein M comprises at least one of B, Y, Nb, In, La, Zr, Ce, W, Al, Ti, Sr, Mg, Sb, V, Zn, Cu, Cr, and Fe, 0.8≤x≤1.2, 0<y<1, 0<z<1, 0<k<1, 0≤p≤0.1.

10. The positive electrode active material according to claim 3, wherein the positive electrode active material comprises a compound having a chemical formula of LiₓNi_{y}Co_{z}MnₖMₚO₂, and wherein M comprises at least one of B, Y, Nb, In, La, Zr, Ce, W, Al, Ti, Sr, Mg, Sb, V, Zn, Cu, Cr, and Fe, 0.8≤x≤1.2, 0<y<1, 0<z<1, 0<k<1, 0≤p≤0.1.

11. The positive electrode active material according to claim 1, wherein the positive electrode active material comprises a secondary particle, and the secondary particle comprises a primary particle.

12. The positive electrode active material according to claim 2, wherein the positive electrode active material comprises a secondary particle, and the secondary particle comprises a primary particle.

13. The positive electrode active material according to claim 3, wherein the positive electrode active material comprises a secondary particle, and the secondary particle comprises a primary particle.

14. The positive electrode active material according to claim 11, wherein a particle size ratio of the primary particle to the secondary particle is 1:(10-1000).

15. The positive electrode active material according to claim 12, wherein a particle size ratio of the primary particle to the secondary particle is 1:(10-1000).

16. The positive electrode active material according to claim 1, wherein a surface of the positive electrode active material comprises at least one of Li₂CO₃ and LiOH.

17. A secondary battery, comprising a negative electrode active material and a positive electrode active material, wherein, the positive electrode active material satisfying the following relationship:
300≤P*D/Δθ≤800;
wherein P represents a porosity of the positive electrode active material, with a unit of %; D represents a crystal plane dimension of (110) crystal plane of the positive electrode active material, with a unit of Å; Δθ represents a splitting degree between a diffraction angle of the (110) crystal plane and that of (108) crystal plane of the positive electrode active material, with a unit of °.

18. The secondary battery according to claim 17, wherein a leakage current I of the secondary battery is 0 A to 0.1 A at 60° C. under a voltage of 4.5 V to 4.7 V.

19. An electric device, comprising a secondary battery, wherein the secondary battery comprises a negative electrode active material and a positive electrode active material, wherein, the positive electrode active material satisfying the following relationship:
300≤P*D/Δθ≤800;
wherein P represents a porosity of the positive electrode active material, with a unit of %; D represents a crystal plane dimension of (110) crystal plane of the positive electrode active material, with a unit of Å; Δθ represents a splitting degree between a diffraction angle of the (110) crystal plane and that of (108) crystal plane of the positive electrode active material, with a unit of °.
